(19) United States
(12) Patent Application Publication
(10) Pub. No.: US 2024/0308149 A1
(43) Pub. Date: Sep. 19, 2024

(54) COMPONENT MOUNTING MEMBER, CASE, TIMEPIECE AND COMPONENT MOUNTING MEMBER MANUFACTURING METHOD

(71) Applicant: CASIO COMPUTER CO., LTD., Tokyo (JP)

(72) Inventors: Shigeaki SUGIYAMA, Tokyo (JP); Yuji DOI, Tokyo (JP); Shouta NAGASAWA, Tokyo (JP)

(73) Assignee: CASIO COMPUTER CO., LTD., Tokyo (JP)

(21) Appl. No.: 18/603,725

(22) Filed: Mar. 13, 2024

(30) Foreign Application Priority Data
Mar. 14, 2023 (JP) 2023-039714

(51) Int. Cl. B29C 65/48; B29C 65/00; B29C 65/64; B29L 31/00

(52) U.S. Cl. CPC B29C 65/4815; B29C 65/64; B29C 66/742; B29L 2031/727; B29L 2031/739

(57) ABSTRACT

A component mounting member, a case having the component mounting member, a timepiece having the case are provided by which a base member made of metal and a terminal are not electrically connected to each other even when the terminal is provided in the base member. Also, a manufacturing method therefor is provided. This component mounting member includes a back cover which is attached to a wristwatch case having an attachment hole, a terminal attachment member which is arranged in the attachment hole and thereby attached to the back cover, and charging terminals provided in and exposed from the terminal attachment member, in which the back cover is made of metal, and the terminal attachment member is made of an insulative resin. As a result of this structure, the back cover and the charging terminal provided therein are prevented from being electrically connected to each other.

### CROSS-REFERENCE TO RELATED APPLICATION

This application is based upon and claims the benefit of priority from the prior Japanese Patent Application No. 2023-039714 filed Mar. 14, 2023, the entire contents of which are incorporated herein by reference.

### BACKGROUND

### 1. Technical Field

The present disclosure relates to a component mounting member that is used in electronic devices, such as timepieces, cellular phones, and portable information terminals, a case having the component mounting member, a timepiece having the case, and a manufacturing method of the component mounting member.

### 2. Description of the Related Art

For example, a wristwatch is known which has a base member serving as a housing and made of a conductive material such as metal or a conductive resin including carbon resin in order to achieve slimming down and weight saving, as described in Japanese Patent Application Laid-Open (Kokai) Publication No. 2018-169360.

### SUMMARY

An embodiment of the present disclosure is a component mounting member comprising: a base member which has an attachment hole and is attached to a case; an attachment member which is attached to the base member by being inserted into the attachment hole of the base member; and a terminal which is inserted into the attachment member and has at least one portion exposed to outside, wherein the base member is formed of metal, and the attachment member is formed of an insulative resin.

The above and further objects and novel features of one embodiment will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an enlarged front view of an embodiment in which the present disclosure has been applied in a wristwatch;

FIG. 2 is an enlarged back view of the wristwatch shown in FIG. 1;

FIG. 3 is an enlarged cross-sectional view of the wristwatch inverted and taken along the A-A arrow view in FIG. 2;

FIG. 4 is an enlarged back view of the back cover of the wristwatch shown in FIG. 2;

FIG. 5 is an enlarged cross-sectional view of the back cover inverted and taken along the B-B arrow view in FIG. 4;

FIG. 6 is a further enlarged cross-sectional view of a main portion of a component mounting member in the back cover shown in FIG. 5;

FIG. 7 is an enlarged cross-sectional view showing the molding of a product for the component mounting member in the back cover shown in FIG. 5 by a molding die; and

FIG. 8 is an enlarged cross-sectional view of the main portion in a modification example where the providing area of a primer layer in the back cover of the wristwatch where the present disclosure has been applied is different.

### DETAILED DESCRIPTION OF THE PREFERRED EMBODIMENT

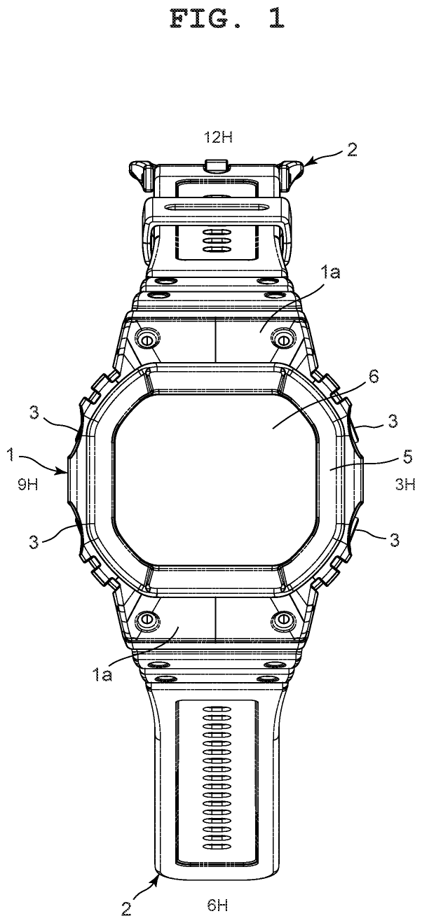

An embodiment of a wristwatch in which the present disclosure has been applied will hereinafter be described with reference to FIG. 1 to FIG. 7.

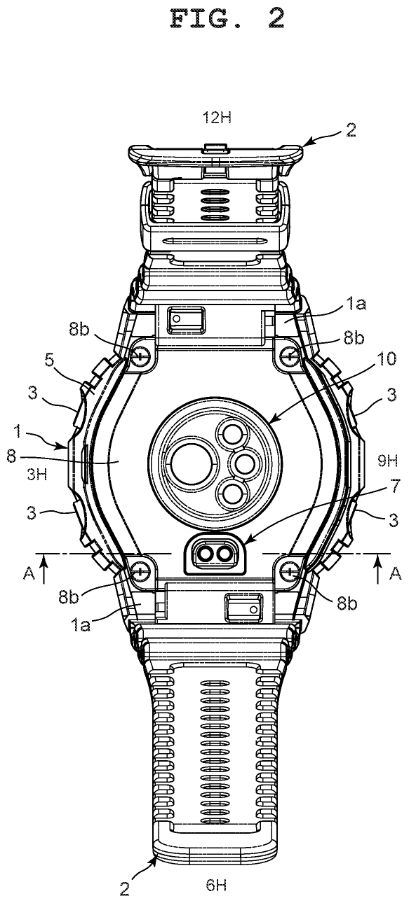

This wristwatch includes a wristwatch case 1, as shown in FIG. 1 and FIG. 2. To the six o'clock side and twelve o'clock side of the wristwatch case 1, band attachment sections 1a to which watch bands 2 are attached are provided. Also, on the two o'clock side, four o'clock side, eight o'clock side, and ten o'clock side of the wristwatch case 1, switch sections 3 are provided, respectively.

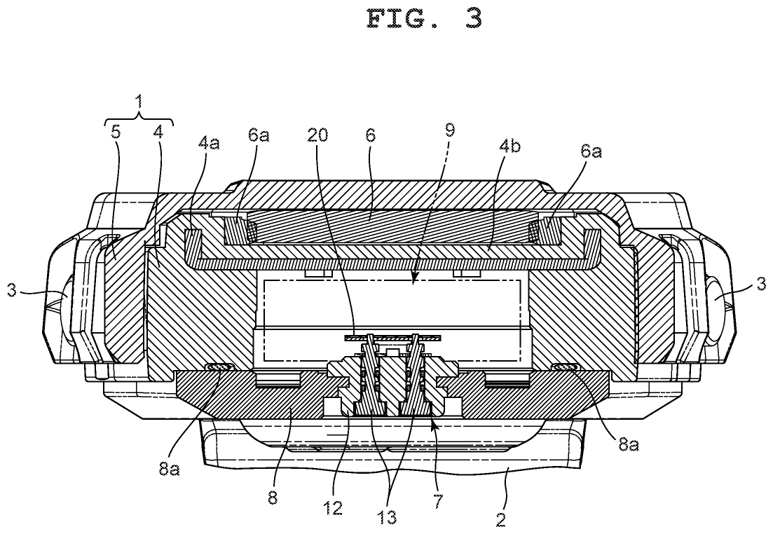

This wristwatch case 1 includes a main body case 4 and an exterior case 5, as shown in FIG. 3. The main body case 4 is made of a fiber-reinforced resin acquired by carbon fibers or glass fibers being mixed into resin serving as a base, and therefore is light and rigid. In this main body case 4, a reinforcement member 4a such as metal is embedded into the resin serving as the base.

In the present embodiment, the above-described resin that serves as the base may be rigid polyamide. Note that the main body case 4 may be formed using not synthetic resin but metal. The exterior case 5 is structured to be attached covering the outer circumferential surface of the main body case 4, as shown in FIG. 1 to FIG. 3. This exterior case 5 is formed using a hard metal such as stainless steel or titanium alloy, or an elastic synthetic resin such as urethane resin.

To the upper opening of the main body case 4 of the wristwatch case 1, a watch glass 6 is attached via a glass packing 6a, as shown in FIG. 1 to FIG. 3. In the present embodiment, on a rim portion of the main body case 4 (FIG. 3 shows the six o'clock side thereof), an arrangement section 4b is formed on which the watch glass 6 is arranged together with the glass packing 6a. In addition, on the lower part of the wristwatch case 1, a back cover 8 which is the base member of a component mounting member 7 described later is attached by a plurality of screws 8b via a waterproof ring 8a, as shown in FIG. 2 and FIG. 3.

Also, in the wristwatch case 1, a timepiece module 9 is provided, as shown in FIG. 3. Although not shown in the drawings, this timepiece module 9 includes various types of components required for timepiece functions, such as a timepiece movement which moves pointers to indicate the time, a display device which electro-optically displays various information such as a time of day, a date, and a day of the week, a circuit section which electrically controls the timepiece movement and the display device, and a rechargeable battery which supplies electric power to the circuit section.

The back cover 8 has a substantially rectangular plate shape whose three o'clock side and nine o'clock side project in arch shapes, as shown in FIG. 2 and FIG. 3. In a central portion of this back cover 8, a sensor device 10 is provided. This sensor device 10, which is an optical sensor for detecting a pulse rate and oxygen saturation in blood, includes a plurality of light emitting elements (not shown in the drawings) and a light receiving element (not shown in the drawings), and is electrically connected to the circuit section (not shown in the drawings) in the timepiece module 9. The plurality of light emitting elements emits light of a green wavelength, light of a red wavelength, and light of an infrared wavelength.

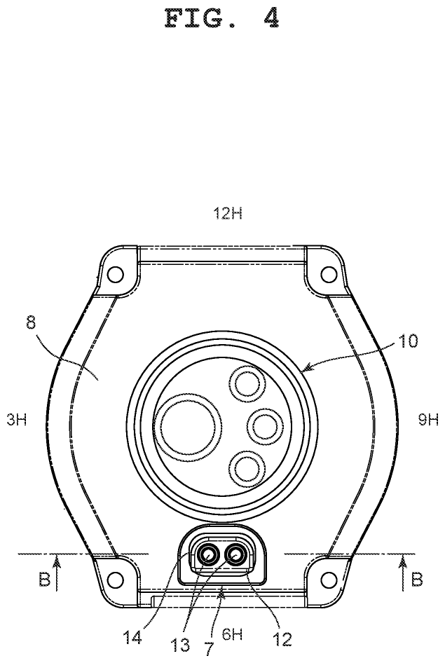

As a result, the sensor device 10 is structured such that light emitted by the plurality of light emitting elements is applied to blood vessels under the skin of an arm, reflected light resulting from the emitted light is received by the light receiving element, a pulse rate is detected on the basis of change in the received amount of reflected light of the green wavelength, and oxygen saturation in blood is detected on the basis of the ratio between transmitted light of the red wavelength and transmitted light of the infrared wavelength which have passed through the body, as shown in FIG. 2 and FIG. 4.

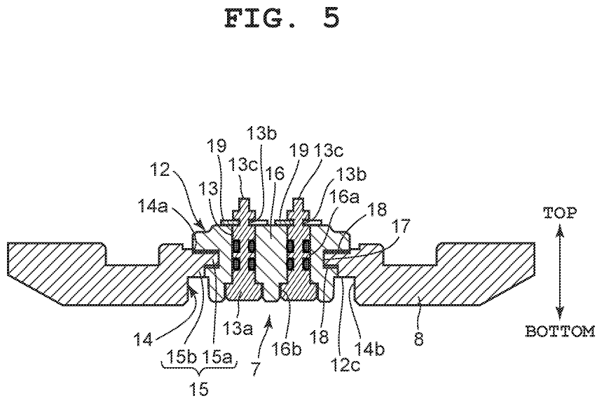

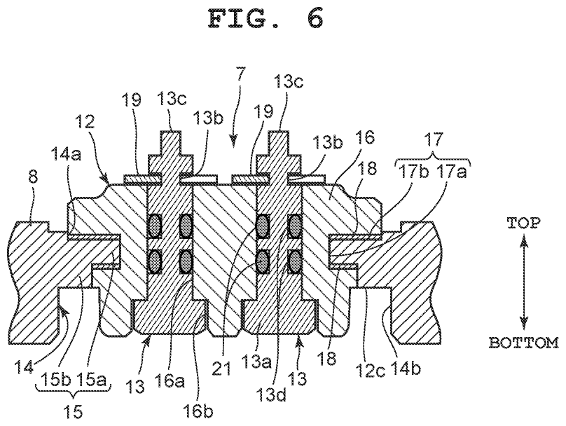

In the wristwatch case 1, the component mounting member 7 is provided, as shown in FIG. 2 to FIG. 4. This component mounting member 7 includes the back cover 8 which serves as its base member, a terminal attachment member 12 which is an attachment member that is attached to the six o'clock side of the back cover 8, and a plurality of charging terminals 13 that is attached to the terminal attachment member 12, as shown in FIG. 5 and FIG. 6.

The back cover 8 which is a base member is made of a conductive metal such as stainless steel, as shown in FIG. 2 to FIG. 6. For example, this back cover 8 is formed using a sintered metal acquired by metal powder such as stainless steel and resin powder being mixed in a flowable state, injected to fill a sintering die, and heated such that the resin powder is vaporized and the metal powder is sintered.

On the six o'clock side of the back cover 8, an attachment hole 14 in which the terminal attachment member 12 is arranged is formed penetrating from the inner surface (upper surface in FIG. 5 and FIG. 6) of the back cover 8 to the outer surface (undersurface in FIG. 5 and FIG. 6) thereof, as shown in FIG. 5 and FIG. 6. This attachment hole 14 is a substantially rectangular through hole which is long from the five o'clock side toward the seven o'clock side and whose four corners are rounded. Note that this attachment hole 20 may have a substantially ellipse shape.

On the inner surface of the attachment hole 14, a fitting projection section 15 is provided projecting in a brim shape, as shown in FIG. 5 and FIG. 6. This fitting projection section 15 is formed such that its length (thickness) in a vertical direction is about half the length (thickness) of the back cover 8 in the vertical direction, and is positioned on the upper side in the attachment hole 14. In addition, this fitting projection section 15 includes a first projection section 15a which greatly project toward the inner side of the attachment hole 14, and a second projection section 15b whose projection length is shorter than that of the first projection section 15a.

The first projection section 15a is formed on the upper surface side (inner surface side) of the back cover 8 located on the inner side of the wristwatch case 1, as shown in FIG. 5 and FIG. 6. In addition, the second projection section 15b is formed on a middle portion of the back cover 8 in the vertical direction. Also, the attachment hole 14 includes a first hole section 14a located over the fitting projection section 15 and a second hole section 14b located under the fitting projection section 15.

The first hole section 14a located on the upper side and the second hole section 14b located on the lower side are formed such that their inner diameters are substantially the same, as shown in FIG. 5 and FIG. 6. Also, the first hole section 14a located on the upper side is formed such that its length (depth) in the vertical direction is short (shallow). Moreover, the second hole section 14b located on the lower side is formed such that its length (depth) in the vertical direction is sufficiently longer (deeper) than the vertical length (depth) of the first hole section 14a located on the upper side.

On the other hand, the terminal attachment member 12 is made of an insulative resin material, as shown in FIG. 5 and FIG. 6. This resin material is, for example, a fiber-reinforced resin acquired by glass fibers being mixed into polyarylate resin. Also, the terminal attachment member 12 includes a main body section 16 to which the plurality of charging terminals 13 is attached, and a groove section 17 which is formed in the outer circumferential part of the main body section 16 and into which the first projection section 15a of the fitting projection section 15 is fitted.

The main body section 16 is structured to be arranged in the attachment hole 14 of the back cover 8, as shown in FIG. 4 to FIG. 6. More specifically, the main body section 16 is formed such that the outer diameter of its upper part is substantially equal to the inner diameter of the first hole section 14a of the attachment hole 14 in the back cover 8, and this upper part has a substantially rectangular shape. In addition, the main body section 16 is formed such that the outer diameter of its lower part is shorter than the inner diameter of the second hole section 14b of the attachment hole 14, and this lower part has a shape, which is a substantially rectangular shape, and a size corresponding to the end surface of the second projection section 15b of the fitting projection section 15. As a result, the main body section 16 is formed is formed such that the outer diameter of its upper part is longer than the outer diameter of its lower part.

Also, the main body section 16 is formed such that its length (thickness) in the vertical direction is longer (thicker) than the vertical length (depth) of the attachment hole 14 of the back cover 8, that is, the vertical length of the back cover 8, as shown in FIG. 5 and FIG. 6. As a result, the main body section 16 is structured such that, when its undersurface is arranged to be substantially flush with the undersurface of the back cover 8, its upper surface is arranged projecting higher than the inner surface (upper surface in FIG. 5 and FIG. 6) of the back cover 8.

The groove section 17 of the terminal attachment member 12, into which the first projection section 15a of the fitting projection section 15 formed in the attachment hole 14 of the back cover 8 is fitted, is provided in a substantially middle portion of the outer circumferential surface of the main body section 16 of the terminal attachment member 12 in the vertical direction, as shown in FIG. 5 and FIG. 6. This groove section 17 has a recess shape substantially corresponding to an end portion of the first projection section 15a projecting further than the second projection section 15b toward the inside of the attachment hole 14. Also, this groove section 17 includes a recess section 17a into which the end portion of the first projection section 15a is inserted, and a placement surface 17b which is arranged on the upper surface of the first projection section 15a.

This terminal attachment member 12 is formed such that the outer diameter of the lower part of the main body section 16 is shorter than the inner diameter of the second hole section 14b at the lower part of the attachment hole 14 in the back cover 8, as shown in FIG. 5 and FIG. 6. Accordingly, in an area between the outer circumferential surface of the lower part of the main body section 16 and the inner circumferential surface of the second hole section 14b at the lower part of the attachment hole 14 in the back cover 8, a restriction recess section 12c is formed. By this restriction recess section 12c, when a connection section (not shown in the drawings) of an alligator-type charging device (not shown in the drawings) is inserted thereinto and connected to the charging terminals 13, the position of the charging device with respect to the wristwatch case 1 is restricted.

Also, this terminal attachment member 12 is integrally formed with the attachment hole 14 of the back cover 8 by insert molding when it is formed using an insulative resin, as shown in FIG. 5 and FIG. 6. When being integrally formed with the attachment hole 14 of the back cover 8, this terminal attachment member 12 is adhered to the back cover 8 via a primer layer 18 that is an adhesive layer.

This primer layer 18 is to adhere the terminal attachment member 12 and the back cover 8 to each other by applying an adhesive and clayey fluid to the inner surface of the attachment hole 14 of the back cover 8, drying the fluid so that it turns into a gel, and melting the gel by heat resulting from the molding of the terminal attachment member 12 by resin. As a result, the primer layer 18 adheres the terminal attachment member 12 and the back cover 8 to each other such that high waterproofness to withstand a pressure of about twenty atmospheres is achieved.

In particular, by the primer layer 18 being applied and dried to be a gel, the primer layer 18 is evenly spread, and the surface of the applied primer layer 18 becomes relatively flat, whereby uneven application does not easily occur. As a result, the surface of the primer layer 18 is smoothed, whereby the reliability of the waterproofness can be enhanced. Here, if the viscosity of the primer layer 18 is low, a troublesome situation such as dripping or unnecessary adhesion occurs. However, by the primer layer 18 being dried to be a gel, the workability can be enhanced.

This primer layer 18 is interposed between the inner circumferential surface of the attachment hole 14 of the back cover 8 and the outer circumferential surface of the terminal attachment member 12, as shown in FIG. 5 and FIG. 6. More specifically, this primer layer 18 is provided at least on the upper surface of the first projection section 15a of the fitting projection section 15 provided projecting in the attachment hole 14 and the undersurface of the projecting end portion of the first projection section 15a which is fitted into the recess section 17a of the groove section 17 formed in the main body section 16 of the terminal attachment member 12.

That is, this primer layer 18 is interposed between the portions of the first projection section 15a, which are the upper surface of the first projection section 15a and the undersurface of the projecting end portion of the first projection section 15a, and the surfaces of the groove section 17 of the main body section 16 opposing these portions, that is, the inner surface of the recess section 17a of the groove section 17 and the placement surface 17b thereof, as shown in FIG. 5 and FIG. 6. In addition, this primer layer 18 is provided such that, when the first projection section 15a of the fitting projection section 15 provided in the attachment hole 14 of the back cover 8 is melted while being fitted into the groove section 17 of the terminal attachment member 12, this melted first projection section 15a does not flow out to the outer surface of the back cover 8 and that of the terminal attachment member 12.

The back cover 8 is subjected to finishing treatment. More specifically, the upper and lower surfaces of the fitting projection section 15 provided in the attachment hole 14 of the back cover 8, that is, the upper surface of the first projection section 15a and the undersurface of the projecting end portion of the first projection section 15a are subjected to surface treatment by plasma so that the primer layer 18 is unfailingly provided, as shown in FIG. 6.

In the main body section 16 of the terminal attachment member 12, a plurality of through holes 16a to which the plurality of charging terminals 13 is attached is formed to be aligned in the longitudinal directions of the main body section 16, that is, the three and nine o'clock directions, as shown in FIG. 3 to FIG. 6. The plurality of charging terminals 13 is each formed in a substantially round bar shape so as to be inserted into the plurality of through holes 16a formed in the main body 16 of the terminal attachment member 12.

More specifically, each charging terminal 13 is formed such that its outer diameter is substantially equal to the inner diameter of each through hole 16a of the main body section 16 and its vertical length is longer than the vertical length (thickness) of the main body section 16. Also, these charging terminals 13, each of which has a round bar shape, are made of metal such as stainless steel, and have gold-plated surfaces.

At the lower end of each of the plural charging terminals 13, a head section 13a which has a large outer diameter to serve as a stopper is formed, as shown in FIG. 5 and FIG. 6. Accordingly, in the lower part of each through hole 16a of the main body section 16, a large-diameter hole section 16b into which the corresponding head section 13a is inserted is formed. Also, in an upper end portion of each charging terminal 13, a stopper groove 13b is annularly formed to which a stopper member 19 such as an E-ring is attached.

Consequently, the plurality of charging terminals 13 is structured such that, when each charging terminal 13 is inserted from below into the corresponding through hole 16a formed in the main body section 16 and the head sections 13a are arranged in the large-diameter hole sections 16b of the through holes 16a, the stopper grooves 13b in the upper end portions are exposed above the main body section 16, and the stopper members 19 are attached to the exposed stopper grooves 13b, as shown in FIG. 5 and FIG. 6.

As a result, the plurality of charging terminals 13 is structured not to vertically slip out of the through holes 16a of the main body section 16 by the head sections 13a and the stopper members 19 when the head sections 13a at the lower ends are exposed to the outer surface side (the lower surface side in FIG. 5 and FIG. 6) of the back cover 8 from the attachment hole 14 of the back cover 8 without protruding therefrom and the upper end portions of the charging terminals 13 protrude and are exposed to the inner surface side (the upper surface side in FIG. 5 and FIG. 6) of the back cover 8, as shown in FIG. 5 and FIG. 6.

On the upper end of each of the plural charging terminals 13, a connection projection 13c is formed which has a short diameter and is electrically connected to the circuit section (not shown in the drawings) of the timepiece module 9 in the wristwatch case 1 by a connection member 20 such as a flexible wiring substrate, as shown in FIG. 3. In addition, in the outer circumferential surfaces of the plurality of charging terminals 13, a plurality of waterproof grooves 13d is annularly provided, as shown in FIG. 6.

In these waterproof grooves 13d, waterproof packings 21 are provided as shown in FIG. 6, and each waterproof packing 21 is structured such that its portion exposed from the corresponding waterproof groove 13d comes in pressure contact with the inner circumferential surface of the corresponding through hole 16a of the main body section 16 so as to achieve waterproofing between the outer circumferential surface of each charging terminal 13 and the inner circumferential surface of each through hole 16a of the main body section 16.

The component mounting member 7 of the wristwatch case 1 is structured such that the charging device (not shown in the drawings) which charges the rechargeable battery (not shown in the drawings) of the timepiece module 9 is electrically connected thereto. This charging device, which is an alligator-type clip device that holds the wristwatch case 1 from above and below, includes the connection section (not shown in the drawings) that is connected to the plurality of charging terminals 13 provided in the terminal attachment member 12 of the back cover 8. As a result, the charging device is structured to charge the rechargeable battery of the timepiece module 9 with the connection section being connected to the plurality of charging terminals 13.

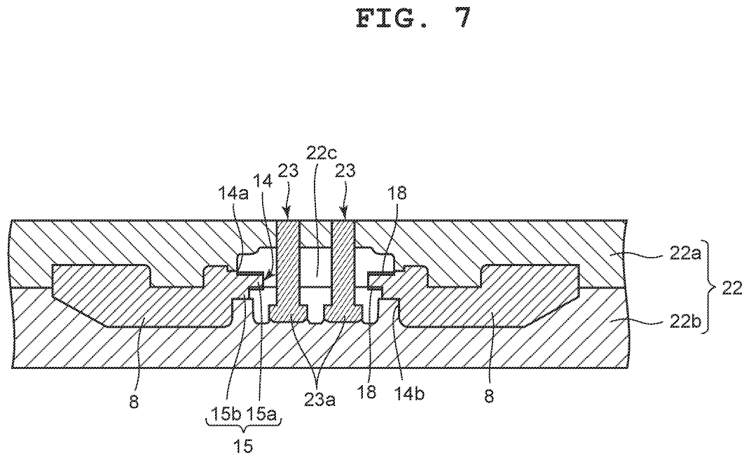

Next, a manufacturing method for manufacturing the component mounting member 7 of this wristwatch is described. This method for manufacturing the component mounting member 7 includes a first step of molding the back cover 8 which is a base member by use of metal, and a second step of molding the terminal attachment member 12 to which the charging terminals 13 are attached by use of an insulative resin material in a manner that the terminal attachment member 12 is integrally molded with the back cover 8, as shown in FIG. 7.

Although not shown in the drawings, at the first step, a sintering die is used to mold the back cover 8. More specifically, the back cover 8 is acquired by conductive metal powder being sintered in the sintering die. That is, this back cover 8 is a sintered metal acquired by, for example, metal powder such as stainless steel and resin powder being mixed in a flowable state, injected to fill the sintering die, and heated such that the resin powder is vaporized and the metal powder is sintered.

At this first step, the attachment hole 14 is formed on the six o'clock side of the back cover 8 in a manner to penetrate vertically, as shown in FIG. 7. On the inner surface of this attachment hole 14, the fitting projection section 15 is formed projecting in a flange shape. In the upper part of this fitting projection section 15, the first hole section 14a is formed. In addition, in the lower part of this fitting projection section 15, the second hole section 14b is formed. This fitting projection section 15 includes the first projection section 15a whose projection length is long and the second projection section 15b whose projection length is shorter than that of the first projection section 15a.

Also, at this first step, the molded back cover 8 is subjected to finishing treatment, whereby the primer layer 18 which is an adhesion layer is formed, as shown in FIG. 7. In this treatment, the upper surface of the first projection section 15a on the upper side of the fitting projection section 15 formed in the attachment hole 14 of the back cover 8 and the undersurface of the projecting end portion of the first projection section 15a projecting further than the second projection section 15b are subjected to surface treatment by plasma so that the primer layer 18 is easily formed.

Then, when the primer layer 18 is to be formed on the inner surface of the attachment hole 14 of the back cover 8, an adhesive and clayey fluid is applied to the upper surface of the first projection section 15a of the fitting projection section 15 and the undersurface of the projecting end portion of the first projection section 15a, and dried into a gel form. Here, since the upper surface of the first projection section 15a of the fitting projection section 15 and the undersurface of the projecting end portion of the first projection section 15a have been subjected to the surface treatment by plasma, the fluid for the primer layer 18 is unfailingly applied. As a result, the primer layer 18 is unfailingly formed on the upper surface and undersurface of the first projection section 15a of the fitting projection section 15 subjected to the surface treatment by plasma.

At the second step, the back cover 8 is arranged in a molding die 22, and the terminal attachment member 12 is integrally formed in the attachment hole 14 of the back cover 8 by insert molding, as shown in FIG. 7. This molding die 22 includes an upper die 22a and a lower die 22b. In this molding die 22, a cavity section (cavity) 22c having the same shape as the terminal attachment member 12 is formed in an area that is surrounded by the upper die 22a and the lower die 22b when the back cover 8 is arranged between the upper die 22a and the lower die 22b.

In the cavity section 22c of the molding die 22, a plurality of insertion pins 23 is arranged which is used for forming the through holes 16a that are insertion holes where the plurality of charging terminals 13 is inserted, as shown in FIG. 7. Each of these insertion pins 23 has the same shape as the corresponding through hole 16a formed in the terminal attachment member 12 and the corresponding large-diameter hole section 16b. More specifically, each insertion pin 23 is formed to have a substantially same size as each charging terminal 13, and has a head section 23a whose size is substantially equal to the head section 13a of each charging terminal 13.

That is, when the terminal attachment member 12 is to be molded by this molding die 22, the back cover 8 is arranged in the molding die 22 and the plurality of insertion pins 23 is arranged in the cavity section 22c of the molding die 22, as shown in FIG. 7. In this state, an insulative resin material is melted, injected to fill the cavity section 22c of the molding die 22, and solidified. This resin material is, for example, an insulative fiber-reinforced resin acquired by glass fibers being mixed into polyarylate resin.

As a result, the main body section 16 of the terminal attachment member 12 is integrally formed in the attachment hole 14 of the back cover 8 with the plurality of insertion pins 23 being arranged in the main body section 16. Here, by the heat of the insulative resin material injected to fill the cavity section 22c of the molding die 22, the primer layer 18 provided on the upper surface and undersurface of the first projection section 15a of the fitting projection section 15 in the attachment hole 14 of the back cover 8 and dried to be a gel is welded.

This melted primer layer 18 does not flow out to the outer surfaces of the back cover 8 and the terminal attachment member 12 even when the first projection section 15a of the fitting projection section 15 formed in the attachment hole 14 of the back cover 8 engages with the groove section 17 of the terminal attachment member 12. Then, when the melted primer layer 18 is solidified, the outer circumferential surface of the terminal attachment member 12 and the inner circumferential surface of the attachment hole 14 of the back cover 8 are firmly adhered to each other. As a result, the terminal attachment member 12 and the back cover 8 are adhered to each other such that high waterproofness to withstand a pressure of about twenty atmospheres is achieved.

In this state, the upper die 22a and the lower die 22b are separated from each other, and the molded product where the terminal attachment member 12 has been formed in the attachment hole 14 of the back cover 8 is detached from the inner sides of the upper die 22a and the lower die 22b. Then, the plurality of insertion pins 23 in the terminal attachment member 12 of the molded product are detached therefrom. As a result, the plurality of through holes 16a is precisely formed in the terminal attachment member 12. Here, in the lower parts of these plural through holes 16a, the large-diameter hole sections 16b where the head sections 13a of the charging terminals 13 are arranged are formed by the head sections 23a of the insertion pins 23.

This manufacturing method for manufacturing the component mounting member 7 further includes a third step of attaching the plurality of charging terminals 13 to the molded product. At the third step, the plurality of charging terminals 13 is attached to the terminal attachment member 12 of the molded product, or more specifically, the plurality of through holes 16a of the terminal attachment member 12 integrally formed in the attachment hole 14 of the back cover 8, as shown in FIG. 6.

Before this attachment, the plurality of waterproof packings 21 is attached to the plurality of waterproof grooves 13d formed in the outer circumferential surface of each charging terminal 13, as shown in FIG. 6. In this state, the small-diameter connection projection 13c sides of the plurality of charging terminals 13 are inserted from below into the plurality of through holes 16a of the terminal attachment members 12, and the head sections 13a of the plurality of charging terminals 13 are arranged in the large-diameter hole sections 16b of the plurality of through holes 16a.

Here, the plurality of waterproof packings 21 arranged in the plurality of waterproof grooves 13d formed in the outer circumferences of the charging terminals 13 come in pressure contact with the inner surfaces of the plurality of through holes 16a, whereby waterproofing between each of the plurality of through holes 16a and the corresponding charging terminal 13 is achieved, as shown in FIG. 6. Also, since the connection projections 13c of the plurality of charging terminals 13 project above the terminal attachment member 12, the stopper members 19 are attached to the stopper grooves 13b formed on the lower end sides of the projecting connection projections 13c. As a result, the plurality of charging terminals 13 is attached to the terminal attachment member 12, whereby the manufacturing of the component mounting member 7 is ended.

Then, the back cover 8, which is the component mounting member 7, is attached to the wristwatch case 1. Here, before this attachment, the watch glass 6 is attached to the upper opening of the main body case 4 of the wristwatch case 1 together with the glass packing 6a, as shown in FIG. 3. In this state, the plurality of switch sections 3 is attached to side portions of the wristwatch case 1, and the exterior case 5 is attached to the outer circumferential part of the main body case 4. Then, the timepiece module 9 is mounted in the wristwatch case 1.

Here, before this mounting of the timepiece module 9, the connection projections 13c of the plurality of charging terminals 13 provided in the terminal attachment member 12 are electrically connected to the circuit section (not shown in the drawings) of the timepiece module 9 by the connection member 20, and also the sensor device 10 is electrically connected to the circuit section of the timepiece module 9. In this state, by the plurality of screws 8b, the back cover 8 is attached to the lower part of the wristwatch case 1 together with the waterproof ring 8a. As a result, the assembly of the wristwatch that can be charged by the charging device (not shown in the drawings) is ended.

When this wristwatch is to be charged by the charging device (not shown in the drawings), the six o'clock side of the wristwatch case 1 is held from above and below by the charging device which is an alligator-type clip device. Here, the connection section (not shown in the drawings) of the charging device is positioned corresponding to the plurality of charging terminals 13 of the terminal attachment member 12 provided on the six o'clock side of the back cover 8, and fitted into the restriction recess section 12c formed between the inner circumferential surface of the lower part of the attachment hole 14 in the back cover 8 and the outer circumferential surface of the lower part of the terminal attachment member 12.

As a result, the position of the charging device with respect to the wristwatch case 1 is restricted and the connection section of the charging device is electrically connected to the plurality of charging terminals. Accordingly, electric power supplied to the connection section of the charging device is supplied to the plurality of charging terminals 13 of the component mounting member 7, whereby the rechargeable battery (not shown in the drawings) of the timepiece module 9 mounted in the wristwatch case 1 is charged.

As described above, the component mounting member 7 of this wristwatch includes the back cover 8 which is a base member to be attached to the wristwatch case 1 and provided with the attachment hole 14, the terminal attachment member 12 which is arranged in the attachment hole 14 of the back cover 8 and thereby attached to the back cover 8, and the charging terminals 13 provided in and exposed from the terminal attachment member 12. In addition, the back cover 8 is made of metal, and the terminal attachment member 12 is made of an insulative resin. As a result of this structure, although the charging terminals 13 are provided in the back cover 8 made of metal, the back cover 8 and each charging terminal 13 can be prevented from being electrically connected to each other.

In the case of the above-described wristwatch of Japanese Patent Application Laid-Open (Kokai) Publication No. 2018-169360 in which the base member is conductive, a problem occurs in that, when a terminal (such as a charging terminal) is provided in the base member, this charging terminal and the base member are electrically connected to each other, which cripples the function of the charging terminal. However, in the case of the wristwatch in the present embodiment, this problem does not occur.

Also, in the component mounting member 7 of the wristwatch in the present embodiment, the primer layer 18, which is an adhesion layer, is interposed between the terminal attachment member 12 and the back cover 8 that is a base member. As a result, by this primer layer 18, the terminal attachment member 12 and the back cover 8 are reliably and firmly adhered to each other, whereby waterproofness and airtightness between the terminal attachment member 12 and the back cover 8 are ensured.

Moreover, in the case of the component mounting member 7 of this wristwatch, the terminal attachment member 12 and the back cover 8 are integrally formed with the outer circumferential surface of the terminal attachment member 12 and the inner circumferential surface of the attachment hole 14 of the back cover 8 being adhered to each other via the primer layer 18. As a result of this structure, the outer circumferential surface of the terminal attachment member 12 and the inner circumferential surface of the attachment hole 14 of the back cover 8 are further reliably and firmly adhered to each other by the primer layer 18, whereby waterproofness and airtightness between the outer circumferential surface of the attachment terminal member 12 and the inner circumferential surface of the attachment hole 14 of the back cover 8 are further enhanced.

Furthermore, in the case of the component mounting member 7 of this wristwatch, the primer layer 18 which is an adhesive layer reliably and firmly adheres the outer circumferential surface of the terminal attachment member 12 and the inner circumferential surface of the attachment hole 14 of the back cover 8 to each other by an adhesive and clayey fluid being applied to the inner surface of the attachment hole 14 of the back cover 8 which is a base member, dried into a gel form, and melted in this state by heat so as to adhere the terminal attachment member 12 and the back cover 8 to each other. As a result, waterproofness and airtightness between the outer circumferential surface of the terminal attachment member 12 and the inner circumferential surface of the attachment hole 14 of the back cover 8 are enhanced.

Still further, in the case of the component mounting member 7 of this wristwatch, the primer layer 18 is applied and dried to be a gel. Accordingly, the primer layer 18 is evenly spread, and the surface of the applied primer layer 18 becomes relatively flat, whereby uneven application does not easily occur. As a result, the surface of the primer layer 18 is smoothed, whereby the reliability of the waterproofness can be enhanced. Here, if the viscosity of the primer layer 18 is low, a troublesome situation such as dripping or unnecessary adhesion occurs. However, by the primer layer 18 being dried to be a gel, the workability can be enhanced.

Yet still further, in the case of the component mounting member 7 of this wristwatch, the upper surface of the first projection section 15a of the fitting projection section 15 formed in the attachment hole 14 of the back cover 8 and the undersurface of the projecting end portion of the first projection section 15a projecting further than the second projection section 15b are subjected to surface treatment by plasma, whereby the primer layer 18 is reliably and favorably formed on the upper surface of the first projection section 15a and the undersurface of the projecting end portion of the first projection section 15a. As a result, the outer circumferential surface of the terminal attachment member 12 and the inner circumferential surface of the attachment hole 14 of the back cover 8 are reliably and firmly adhered to each other.

Yet still further, in the component mounting member 7 of this wristwatch, the back cover 8 which is a base member includes the fitting projection section 15 formed on the inner surface of the attachment hole 14, and the terminal attachment member 12 includes the main body section 16 to which the charging terminals 13 are attached and which is arranged in the attachment hole 14 of the back cover 8, and the groove section 17 which is formed in the outer circumferential part of the main body section 16 and into which the first projection section 15a of the fitting projection section 15 is fitted. As a result of this structure, the terminal attachment member 12 and the back cover 8 are reliably and firmly adhered to each other.

That is, in the case of the component mounting member 7 of this wristwatch, the fitting projection section 15 formed on the inner surface of the attachment hole 14 in the back cover 8 is fitted into the groove section 17 formed in the outer circumferential surface of the main body section 16 of the terminal attachment member 12. As a result of this structure, the terminal attachment member 12 is reliably and firmly attached to the inside of the attachment hole 14 in the back cover 8.

Also, in the case of the component mounting member 7 of this wristwatch, the primer layer 18 which is an adhesion layer is provided at least on the upper surface of the first projection section 15a and the undersurface of the projecting end portion of the first projection section 15a projecting further than the second projection section 15b, that is, the upper and lower surfaces of the fitting projection section 15 provided in the attachment hole 14 of the back cover 8. As a result of this structure, the back cover 8 and the terminal attachment member 12 are reliably and firmly adhered and attached to each other by the primer layer 18 with the fitting projection section 15 provided on the inner surface of the attachment hole 14 of the back cover 8 being fitted into the groove section 17 formed in the outer circumferential surface of the main body section 16 of the terminal attachment member 12.

That is, in the case of the component mounting member 7 of this wristwatch, the primer layer 18 reliably and firmly adheres the upper surface of the first projection section 15a of the fitting projection section 15 in the attachment hole 14 of the back cover 8 and the undersurface of the projecting end portion of the first projection section 15a to the inner surface of the recess section 17a of the groove section 17 in the main body section 16 of the terminal attachment member 12 and the placement surface 17b which oppose the upper surface of the first projection section 15a and the undersurface of the projecting end portion of the first projection section 15a. As a result of this structure, waterproofness and airtightness between the inner circumferential surface of the attachment hole 14 of the back cover 8 and the outer circumferential surface of the terminal attachment member 12 are ensured.

Also, the manufacturing method for manufacturing the component mounting member 7 of this wristwatch includes the first step of molding the back cover 8 which is a base member having the attachment hole 14 by use of metal, and the second step of molding the terminal attachment member 12, to which the charging terminals 13 are attached, in the attachment hole 14 of the back cover 8 by use of an insulative resin material. As a result, although the charging terminal 13 is provided in the back cover 8 made of metal, the back cover 8 and the charging terminal 13 are prevented from being electrically connected to each other, and the component mounting member 7 is easily and favorably manufactured.

In the manufacturing method for manufacturing the component mounting member 7 of the wristwatch in the present embodiment, at the first step, the primer layer 18 which is an adhesion layer is provided on the inner surface of the attachment hole 14. Then, when the terminal attachment member 12 is being molded at the second step, the terminal attachment member 12 and the back cover 8 are adhered to each other by the primer layer 18. As a result, the outer circumferential surface of the terminal attachment member 12 and the inner circumferential surface of the attachment hole 14 of the back cover 8 are reliably and firmly adhered to each other by the primer layer 18, whereby waterproofness and airtightness between the terminal attachment member 12 and the back cover 8 are ensured.

Also, in the manufacturing method for manufacturing the component mounting member 7 of this wristwatch, the terminal attachment member 12 and the back cover 8 are integrally formed with the outer circumferential surface of the terminal attachment member 12 and the inner circumferential surface of the attachment hole 14 of the back cover 8 being adhered to each other by the primer layer 18. As a result, the outer circumferential surface of the terminal attachment member 12 and the inner circumferential surface of the attachment hole 14 of the back cover 8 are further reliably and firmly adhered to each other by the primer layer 18, whereby waterproofness and airtightness between the outer circumferential surface of attachment member 12 and the inner the terminal circumferential surface of the attachment hole 14 of the back cover 8 are further enhanced.

Moreover, in the manufacturing method for manufacturing the component mounting member 7 of this wristwatch, at the second step, the terminal attachment member 12 is integrally formed in the attachment hole 14 of the back cover 8 by insert molding while the primer layer 18 interposed between the back cover 8 and the terminal attachment member 12 is being melted. As a result, the outer circumferential surface of the terminal attachment member 12 and the inner circumferential surface of the attachment hole 14 of the back cover 8 are reliably and firmly adhered to each other by the primer layer 18, whereby waterproofness and airtightness between the outer circumferential surface of the terminal attachment member 12 and the inner circumferential surface of the attachment hole 14 of the back cover 8 are enhanced.

Furthermore, in the manufacturing method for manufacturing the component mounting member 7 of this wristwatch, at the first step, the primer layer 18 is formed by an adhesive and clayey fluid being applied to the inner surface of the attachment hole 14 of the back cover 8 and dried into a gel form. Then, when the terminal attachment member 12 is being molded in the attachment hole 14 of the back cover 8 by insert molding at the second step, the primer layer 18 is melted by the heat of the resin material of the terminal attachment member 12, whereby the terminal attachment member 12 and the back cover 8 are adhered to each other. As a result of this procedure, when the terminal attachment member 12 is being molded in the attachment hole 14 of the back cover 8 by insert molding at the second step, the primer layer 18 dried into a gel form is unfailingly and favorably melted by the heat of the resin material of the terminal attachment member 12.

In the manufacturing method for manufacturing the component mounting member 7 of the wristwatch in the present embodiment, the primer layer 18 is applied and then dried to be a gel. Accordingly, the primer layer 18 is evenly spread, and the surface of the applied primer layer 18 becomes relatively flat, whereby uneven application does not easily occur. As a result, the surface of the primer layer 18 is smoothed, whereby the reliability of the waterproofness can be enhanced. Here, if the viscosity of the primer layer 18 is low, a troublesome situation such as dripping or unnecessary adhesion occurs. However, by the primer layer 18 being dried to be a gel, the workability can be enhanced.

Accordingly, in the manufacturing method for manufacturing the component mounting member 7 of this wristwatch, when the primer layer 18 melted by the heat of the resin material of the terminal attachment member 12 is solidified, the outer circumferential surface of the terminal attachment member 12 and the inner circumferential surface of the attachment hole 14 of the back cover 8 are reliably and firmly adhered to each other by this solidified primer layer 18, whereby waterproofness and airtightness between the outer circumferential surface of the terminal attachment member 12 and the inner circumferential surface of the attachment hole 14 of the back cover 8 are ensured.

Also, in the manufacturing method for manufacturing the component mounting member 7 of this wristwatch, the terminal attachment member 12 includes the main body section 16 which is arranged in the attachment hole 14 formed in the back cover 8, and the groove section 17 which is formed in the outer circumferential part of the main body section 16 and into which the fitting projection section 15 of the back cover 8 is fitted. At the first step, the fitting projection section 15 is formed on the inner surface of the attachment hole 14 in the back cover 8. Then, at the second step, the terminal attachment member 12 is adhered by the primer layer 18 with the fitting projection section 15 being fitted into the groove section 17. As a result of these steps, the back cover 8 and the main body section 16 of the terminal attachment member 12 are reliably and firmly adhered and attached to each other by the primer layer 18 with the fitting projection section 15 on the inner surface of the attachment hole 14 of the back cover 8 being fitted into the groove section 17 in the outer circumferential surface of the main body section 16 of the terminal attachment member 12.

Moreover, in the manufacturing method for manufacturing the component mounting member 7 of this wristwatch, the primer layer 18 is provided at least on the upper surface of the first projection section 15a of the fitting projection section 15 in the attachment hole 14 of the back cover 8 and the undersurface of the projecting end portion of the first projection section 15a, and thereby reliably and firmly adheres the upper surface and undersurface of the first projection section 15a of the fitting projection section 15 on the inner surface of the attachment hole 14 of the back cover 8 to the inner surface of the recess section 17a of the groove section 17 in the main body section 16 of the terminal attachment member 12 and the placement surface 17b which oppose the upper surface and undersurface of the first projection section 15a, with the first projection section 15a being fitted into the recess section 17a of the groove section 17. As a result, waterproofness and airtightness between the inner circumferential surface of the attachment hole 14 of the back cover 8 and the outer circumferential surface of the terminal attachment member 12 are ensured.

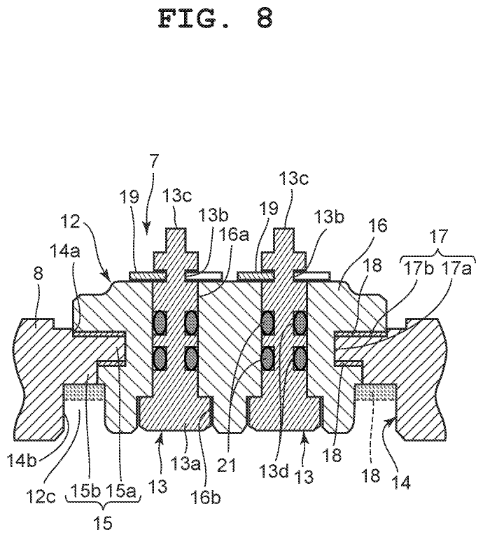

In the above-described embodiment, the primer layer 18 is provided on the upper surface of the first projection section 15a of the fitting projection section 15 in the attachment hole 14 of the back cover 8 and the undersurface of the projecting end portion of the first projection section 15a. However, the present disclosure is not limited thereto, and a structure may be adopted in which the primer layer 18 is also provided on the undersurface of the second projection section 15b of the fitting projection section 15, as indicated by dotted lines of a modification example shown in FIG. 8. By this structure, the waterproofness and the airtightness can be further enhanced.

Also, in the above-described embodiment and the modification example, the primer layer 18 is provided on the upper surface and undersurface of the first projection section 15a of the fitting projection section 15 in the attachment hole 14 of the back cover 8 and the undersurface of the second projection section 15b. However, the present disclosure is not limited thereto and a structure may be adopted in which the primer layer 18 is provided on the entire area of the inner surface of the attachment hole 14 in the back cover 8. More specifically, the primer layer 18 may be provided on the surface extending in the vertical direction, that is, the end surface of the projecting portion of the fitting projection section 15 and the inner surface of the first hole section 14a of the attachment hole 14 and the second hole section 14b thereof, in addition to the horizontal surfaces which are the upper surface and undersurface of the fitting projection section 15.

Moreover, although the charging terminal 13 has been described as the terminal of the above-described embodiment, the present disclosure is not limited thereto. The terminal of the above-described embodiment is not necessarily required to be a charging terminal and may be any terminal such as a connection terminal for communication.

Furthermore, in the above-described embodiment, the present disclosure has been applied in a wristwatch. However, the present disclosure is not necessarily required to be applied in a wristwatch. For example, the present disclosure is applicable to various types of timepieces such as a travel watch, an alarm clock, a table clock, and a wall clock.

In addition, the present disclosure is not necessarily required to be applied in timepieces, and can be applied in electronic devices such as cell-phones and portable information terminals. In that case, although the back cover 8 has been described as the base member of the above-described embodiment, the base member of the present disclosure is not necessarily required to be a back cover, and may be any object as long as it can be attached to a case.

While the present invention has been described with reference to the preferred embodiments, it is intended that the invention be not limited by any of the details of the description therein but includes all the embodiments which fall within the scope of the appended claims.

What is claimed is:

1. A component mounting member comprising:
a base member which has an attachment hole and is attached to a case;
an attachment member which is attached to the base member by being inserted into the attachment hole of the base member; and
a terminal which is inserted into the attachment member and has at least one portion exposed to outside,
wherein the base member is formed of metal, and the attachment member is formed of an insulative resin.

2. The component mounting member according to claim 1, wherein an adhesion layer is provided at least on part of an area between the attachment member and the base member.

3. The component mounting member according to claim 1, wherein the attachment member and the base member are integrally formed with an outer circumferential surface of the attachment member and an inner circumferential surface of the attachment hole of the base member being adhered to each other via an adhesion layer.

4. The component mounting member according to claim 2, wherein the attachment member and the base member are integrally formed with an outer circumferential surface of the attachment member and an inner circumferential surface of the attachment hole of the base member being adhered to each other via the adhesion layer.

5. The component mounting member according to claim 2, wherein the adhesive layer adheres the attachment member and the base member to each other by an adhesive and clayey fluid being applied to an inner circumferential surface of the attachment hole of the base member, dried into a gel form, and melted by heat.

6. The component mounting member according to claim 2, wherein the base member includes a fitting projection formed by at least part of an inner circumferential surface of the attachment hole extending inward, and
wherein the attachment member includes a main body into which the terminal is inserted and which is inserted into the attachment hole of the base member, and a groove which is formed in an outer circumferential part of the main body and into which the fitting projection of the attachment hole of the base member is fitted.

7. The component mounting member according to claim 6, wherein the adhesion layer is provided at least on part of an upper surface and undersurface of the fitting projection.

8. The component mounting member according to claim 7, wherein the fitting projection includes a first projection provided on an upper side and a second projection provided on a lower and outer side than the first projection,
wherein the adhesion layer is provided on an upper surface and undersurface of the first projection, and not provided on a side surface of the first projection.

9. The component mounting member according to claim 6, wherein a length of the fitting projection of the base member in a vertical direction is substantially half of a length of the base member in the vertical direction, and
wherein the fitting projection is provided on an upper side of the inner circumferential surface of the attachment hole.

10. The component mounting member according to claim 9, wherein the fitting projection includes a first projection provided on an upper side and a second projection provided on a lower and outer side than the first projection, and
wherein the first projection is included in part of an upper surface of the base member, and the second projection is provided on a middle portion of the base member in the vertical direction.

11. The component mounting member according to claim 6, wherein a length of the attachment member in a vertical direction is longer than a length of the base member in the vertical direction, and
wherein an undersurface of the attachment member and an undersurface of the base member are positioned at a substantially same height in the vertical direction when the fitting projection is fitted into the groove.

12. The component mounting member according to claim 11, wherein a restriction recess is provided between an outer circumferential surface of a lower part of the attachment member and an inner circumferential surface of a lower part of the base member.

13. A case comprising the component mounting member according to claim 2.

14. A timepiece comprising the case according to claim 13.

15. A manufacturing method for manufacturing a component mounting member, comprising:
a first step of molding a base member having an attachment hole by use of metal, and
a second step of molding an attachment member, to which a terminal is attached, in the attachment hole of the base member by use of an insulative resin.

16. The manufacturing method for manufacturing the component mounting member according to claim 15, wherein an adhesion layer is provided on an inner surface of the attachment hole at the first step, and
wherein the attachment member and the base member are adhered to each other by the adhesion layer when the attachment member is molded at the second step.

17. The manufacturing method for manufacturing the component mounting member according to claim 16, wherein the attachment member is integrally formed in the attachment hole of the base member by insert molding while the adhesion layer interposed between the base member and the attachment member is being melted, at the second step.

18. The manufacturing method for manufacturing the component mounting member according to claim 16, wherein the adhesion layer is formed by an adhesive and clayey fluid being applied to the inner surface of the attachment hole of the base member and dried into a gel form at the first step, and
wherein the attachment member and the base member are adhered to each other by the adhesive layer being melted by heat of the resin of the attachment member when the attachment member is molded in the attachment hole of the base member by insert molding at the second step.

19. The manufacturing method for manufacturing the component mounting member according to claim 16, wherein the attachment member includes a main body which is arranged in the attachment hole formed in the base member, and a groove which is formed in an outer circumferential part of the main body and into which a fitting projection of the base member is fitted,
wherein the fitting projection is formed on the inner surface of the attachment hole of the base member at the first step, and
wherein the attachment member is adhered by the adhesion layer with the fitting projection being fitted into the groove, at the second step.
